(19) United States
(12) Patent Application Publication
(10) Pub. No.: US 2026/0121218 A1
(43) Pub. Date: Apr. 30, 2026

(54) BATTERY HOUSING AND BATTERY PACK

(71) Applicant: SK ON CO., LTD., Seoul (KR)

(72) Inventor: Seung Il KWAK, Daejeon (KR)

(21) Appl. No.: 19/315,861

(22) Filed: Sep. 2, 2025

(30) Foreign Application Priority Data
Oct. 28, 2024 (KR) 10-2024-0148232

(51) Int. Cl. H01M 50/383; H01M 50/204; H01M 50/271; H01M 50/30; H01M 50/358

(52) U.S. Cl. CPC H01M 50/383; H01M 50/204; H01M 50/271; H01M 50/358; H01M 50/394

(57) ABSTRACT

According to the present disclosure, there is provided a battery housing comprising a gas guide device having first and second plates spaced apart from each other with a space therebetween, and a case in which a battery module and the gas guide device are accommodated, wherein an opening portion is provided to pass through the first plate and is connected to the space, a guide portion protruding toward the opening portion is provided on the second plate, and the gas guide device being arranged so that the opening portion is oriented toward the battery module.

### CROSS-REFERENCE TO RELATED APPLICATION

This application claims priority to Korean Patent Application No. 10-2024-0148232, filed Oct. 28, 2024, the disclosure of which is hereby incorporated herein by reference in its entirety.

### BACKGROUND

### 1. Field of the Invention

The present disclosure relates to a battery housing and a battery pack.

### 2. Discussion of Related Art

Secondary batteries are energy storage devices that can be charged and discharged through electrochemical reactions. Secondary batteries can be used in various fields using electrical energy. For example, secondary batteries are widely used in mobile devices such as mobile phones, laptops, and tablets, and their wider use is being sought in transportation such as cars, aircraft, and ships. In addition, the demand for secondary batteries is increasing in the field of energy storage systems (ESSs) for utilizing surplus power.

Secondary batteries may be provided in multiple combinations according to voltages, currents, etc., required by loads. That is, the secondary battery may be provided as a single unit battery cell, and a plurality of battery cells may be combined to provide a single battery pack. In some cases, battery cells may be combined into intermediate units such as battery modules, and a plurality of battery modules may be combined to provide a single battery pack.

### SUMMARY

The present disclosure relates to a battery housing and a battery pack.

In some embodiments, a high-temperature and high-pressure gas generated in a battery cell may be guided along a discharge path.

In some embodiments, a flame backflow may be prevented.

In some embodiments, foreign materials such as conductive particles may be prevented from being discharged to the outside.

In some embodiments, stability of the battery pack may be improved.

In some embodiments, rigidity of the battery pack may be improved.

Some embodiments of the present disclosure may be widely applied in green technology fields such as solar power generation and wind power generation using batteries in addition to electric vehicles and battery charging stations. In addition, some embodiments of the present disclosure may be used in eco-friendly electric vehicles and hybrid vehicles to prevent climate change by suppressing air pollution and greenhouse gas emissions.

According to some embodiments of the present disclosure, there is provided a battery housing comprising a gas guide device having first and second plates spaced apart from each other with a space therebetween, and a case in which a battery module and the gas guide device are accommodated, wherein an opening portion is provided to pass through the first plate and is connected to the space, a guide portion protruding toward the opening portion is provided on the second plate, and the gas guide device being arranged so that the opening portion is oriented toward the battery module.

In some embodiments, the case may comprise a first cover in which the battery module is accommodated and one side of which is open, and a second cover in which the gas guide device is accommodated and which is coupled to the open side of the first cover.

In some embodiments, the second cover may comprise a lower cover on which the second plate is supported.

In some embodiments, the gas guide device may be coupled to the case using an adhesive.

In some embodiments, the gas guide device may be coupled to the case by bolting.

In some embodiments, the second cover may further comprise an upper cover, and the gas guide device may be accommodated between the upper cover and the lower cover.

In some embodiments, the upper cover may be provided with a communication hole configured to communicate with the opening portion of the gas guide device.

In some embodiments, the opening portion and the guide portion may be provided at centers of the first plate and the second plate in the width direction.

In some embodiments, the guide portion may protrude to be tapered so that both surfaces in a width direction are provided to be inclined.

In some embodiments, the gas guide device may further comprise a cover member covering a surface of the guide portion.

In some embodiments, the gas guide device may further comprise a first net covering an opening portion.

In some embodiments, the gas guide device may further comprise a support whose inner surface faces the space and which connects the first plate and the second plate.

In some embodiments, a first through-hole may be provided to pass through the inner surface and an outer surface of the support.

In some embodiments, the gas guide device may further comprise a second net covering the first through-hole.

In some embodiments, the gas guide device may further comprise a first net covering the opening portion, a first through-hole may be provided to have inner surface faces the space, connect the first plate and the second plate, and pass through an inner surface and an outer surface of the support, and a second net covering the first through-hole, and a hole of the second net may be smaller than a hole of the first net.

In some embodiments, the gas guide device may comprise a reinforcement connecting the first plate and the second plate on an inner side rather than the support.

In some embodiments, a second through-hole may be provided to pass through an inner surface and an outer surface of the reinforcement.

In some embodiments, a first rib protruding toward the second plate may be provided on the first plate.

In some embodiments, a second rib protruding toward the first plate may be provided on the second plate.

Meanwhile, according to an embodiment of the present disclosure, a battery pack comprising a battery housing and a battery pack comprising the same may be provided.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view illustrating a battery pack according to one embodiment of the present disclosure;

FIG. 2 is an exploded perspective view illustrating the battery pack shown in FIG. 1;

FIG. 3 is a schematic cross-sectional view along line A-A shown in FIG. 1;

FIG. 4 is a schematic cross-sectional view along line B-B shown in FIG. 1;

FIG. 5 is a schematic cross-sectional view along line C-C shown in FIG. 1;

FIG. 6 is a perspective view illustrating a battery pack according to another embodiment of the present disclosure;

FIG. 7 is a cross-sectional view illustrating a gas guide device and a guide member of FIG. 6;

FIG. 8 is an exploded perspective view illustrating a battery pack according to another embodiment of the present disclosure;

FIG. 9 is a first cross-sectional view illustrating the battery pack shown in FIG. 8;

FIG. 10 is a second cross-sectional view illustrating the battery pack shown in FIG. 8;

FIG. 11 is a perspective view illustrating the gas guide device according to one embodiment of the present disclosure;

FIG. 12 is a cross-sectional view illustrating the gas guide device of FIG. 11;

FIG. 13 is a cross-sectional view illustrating a gas guide device according to another embodiment of the present disclosure;

FIG. 14 is a perspective view illustrating a gas guide device according to still another embodiment of the present disclosure;

FIG. 15 is a perspective view illustrating a gas guide device according to yet another embodiment of the present disclosure;

FIG. 16 is a perspective view illustrating a gas guide device according to yet another embodiment of the present disclosure; and

FIG. 17 is a perspective view illustrating a gas guide device according to yet another embodiment of the present disclosure.

### DETAILED DESCRIPTION OF EXEMPLARY EMBODIMENTS

Hereinafter, the present disclosure will be described in detail with reference to the accompanying drawings. However, this is merely exemplary and the present disclosure is not limited to specific embodiments described as examples.

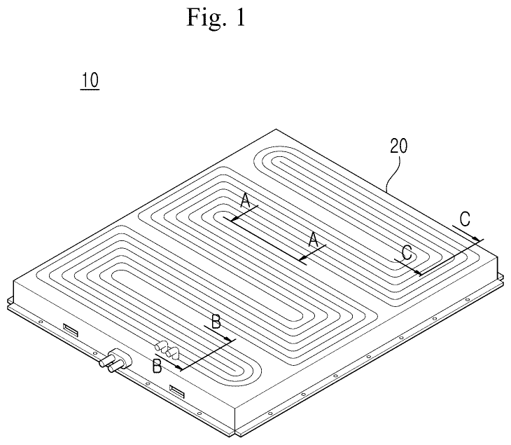

FIG. 1 is a perspective view illustrating a battery pack according to one embodiment of the present disclosure.

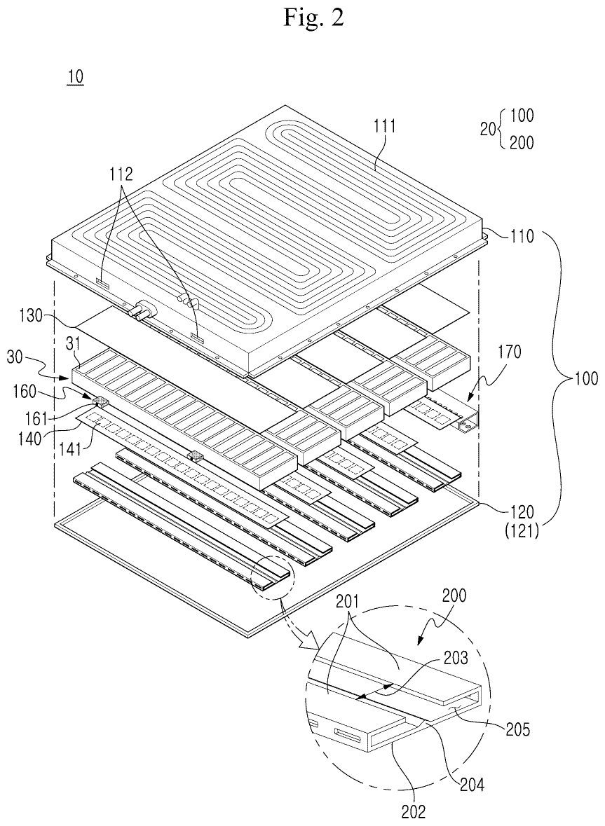

Referring to FIG. 1, the battery pack 10 may comprise a battery housing 20. The battery housing 20 comprises a case 100 having a predetermined accommodation space, and a battery module 30 may be accommodated inside the case 100 (see FIG. 2). That is, according to the present disclosure, the battery pack 10 comprising the battery housing 20 and the battery module 30 accommodated in the case 100 may be provided.

Meanwhile, in the shown embodiment, the battery housing 20 is shown as having a substantially flat rectangular shape. However, the external shape of the battery housing 20 may be changed in some cases and is not necessarily limited to the shown example.

FIG. 2 is an exploded perspective view illustrating the battery pack shown in FIG. 1.

Referring to FIG. 2, according to the present disclosure, the battery housing 20 comprises a gas guide device 200 having first and second plate 201 and 202 disposed to be spaced apart from each other with a space 205 interposed therebetween, the battery module 30, and the case 100 in which the gas guide device 200 is accommodated, wherein the first plate 201 is provided with an opening portion 203 that is connected to the space 205 and is provided to pass therethrough, the second plate 202 is provided with a guide portion 204 that protrudes toward the opening portion 203, and the gas guide device 200 being arranged so that the opening portion 203 is oriented toward the battery module 30.

The battery module 30 may comprise a plurality of battery cells 31 and the case accommodating the battery cells 31. The battery cell 31 may have a cylindrical, prismatic, or pouch shape, and the shape of the battery cell 31 does not limit the present disclosure.

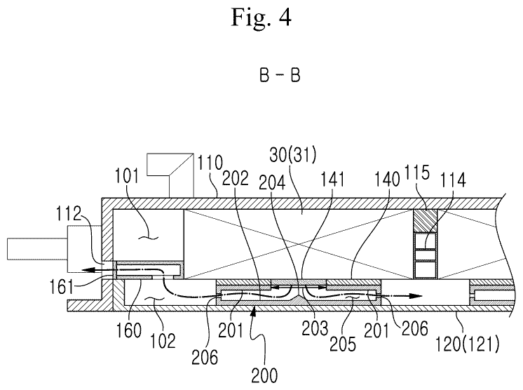

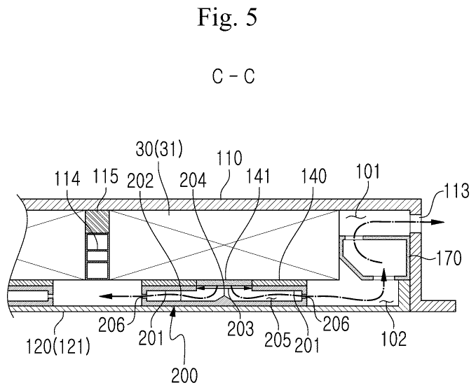

The case 100 may accommodate the battery module 30 and the gas guide device 200. The case 100 may comprise a first cover 110 and a second cover 120, the first cover 110 may comprise a first space 101 in which the battery module 30 is accommodated, and the second cover 120 may comprise a second space 102 in which the gas guide device 200 is accommodated (see FIGS. 4 and 5). In the battery module 30, a vent hole through which a gas generated during thermal runaway of the battery cell is discharged may be disposed to face the opening portion 203 of the gas guide device 200. The drawings show an embodiment in which the vent hole is provided on a bottom surface of the battery cell, and the gas guide device 200 is disposed such that the opening portion 203 faces a bottom surface of the battery module 30 on a lower side of the battery module 30.

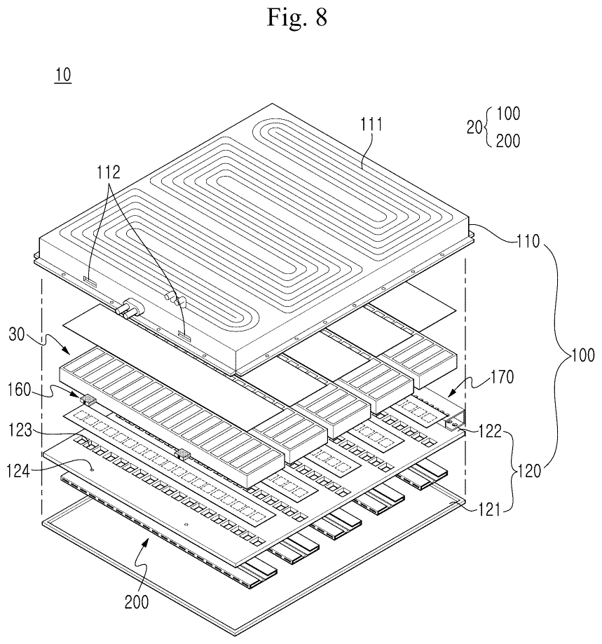

A heat-resistant member 140 may be provided on a side of the battery module 30 where the vent hole is provided. The heat-resistant member 140 can be, for example, a MICA sheet or ceramic wool. A shearing portion 141 may be provided at a portion corresponding to the vent hole of the heat-resistant member 140. The shearing portion 141 is sheared due to a pressure of the gas generated during thermal runaway of the battery cell 31, and the discharged gas may be introduced into the gas guide device 200. The heat-resistant member 140 may be disposed between the battery cell 31 and the gas guide device 200 (see FIG. 4) or between the battery cell 31 and an upper cover 122 (see FIG. 8). A communication hole 123 of the upper cover 122 is provided at a position corresponding to the shearing portion 141 of the heat-resistant member 140, and thus the gas discharged during thermal runaway may shear the shearing portion 141 and may be introduced into the gas guide device 200 through the communication hole 123 and the opening portion 203.

The gas guide device 200 being arranged so that the opening portion 203 is oriented toward the battery module 30. That is, the battery module 30 and the gas guide device 200 may be disposed such that the vent hole and the opening portion 203 face each other. Therefore, the gas generated from the battery cell during thermal runaway may be introduced into the gas guide device 200 through the vent hole and the opening portion 203. The gas guide device 200 may provide a path along which the introduced gas may be discharged to the outside. Meanwhile, although an example in which the gas guide device 200 is disposed at a lower side of the battery module 30 is shown in the drawings, the arrangement of the gas guide device 200 may be appropriately designed according to the position of the vent hole of the battery module 30.

According to one embodiment, the case 100 may comprise a first cover 110 in which the battery module 30 is accommodated and one side of which is open, and a second cover 120 in which the gas guide device 200 is accommodated and which is coupled to the open side of the first cover 110.

A lower side of the first cover 110 based on the drawings may be open. The first cover 110 may comprise a first space 101 in which the battery module 30 is accommodated (see FIG. 4). The battery module 30 may be inserted into the first space 101 through the open side of the first cover 110. The first cover 110 may be provided with a cooling flow path 111 for cooling the battery module 30. In addition, a thermal pad 130 for high thermal conductivity may be disposed between an inner surface of the first cover 110 and the battery module 30. That is, the first space 101 may accommodate the battery module 30 and the thermal pad 130, and as will be described below, the heat-resistant member 140, a first protective member 160, and a second protective member 170 may be accommodated in the first space 101.

The second cover 120 is connected to the open side of the first cover 110 (the lower side based on the drawings) and may close the first space 101. The second cover 120 may comprise a second space 102 in which the gas guide device 200 is accommodated (see FIG. 4).

According to one embodiment, the second cover 120 may comprise a lower cover 121 on which the second plate 202 is supported. That is, the lower cover 121 may be in contact with a lower surface of the gas guide device 200. The lower cover 121 may comprise a bottom portion on which the lower surface of the gas guide device 200 is supported and a side wall portion protruding upward from the lower surface and constituting an edge, and a second space 102 in which the gas guide device 200 is accommodated may be provided between the lower surface and the side wall portion.

Meanwhile, the gas generated from the battery cell may be discharged through the vent hole and may be introduced into the gas guide device 200. As will be described in detail below, the gas introduced into the gas guide device 200 may be guided to be discharged to the outside of the battery housing 20 by the guide portion 204 according to the present disclosure.

The first cover 110 may be provided with a first exhaust hole 112 and a second exhaust hole 113 to allow the gas, which is introduced into the gas guide device 200 and guided to both sides in a width direction, to be discharged to the outside. Based on the drawings, the first exhaust hole 112 may be provided on a front surface of the first cover 110, and the second exhaust hole 113 may be provided on a rear surface of the first cover 110. The first exhaust hole 112 and the second exhaust hole 113 may be provided as a plurality of first exhaust holes 112 and a plurality of second exhaust holes 113, and may be provided to pass through an inner surface and an outer surface of the first cover 110 so that the gas discharged from the battery cell 31 may be guided to the first exhaust hole 112 and the second exhaust hole 113 by the gas guide device 200 and discharged to the outside.

According to one embodiment, the gas guide device 200 may be coupled to the case 100 by an adhesive in the second space 102. According to one embodiment, the gas guide device 200 may be coupled to the case 100 by bolting in the second space 102. That is, the gas guide device 200 may be coupled to the upper cover 122 and/or the lower cover 121 by an adhesive or bolting. The method in which the gas guide device 200 is coupled to the case 100 does not limit the present disclosure and may be performed in any suitable way.

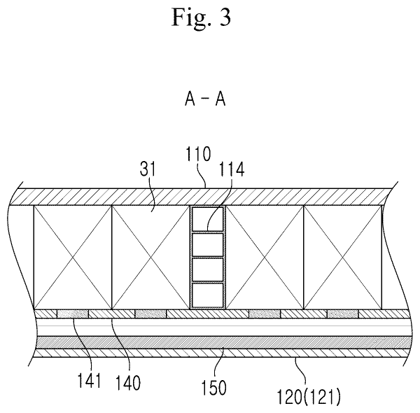

FIG. 3 is a schematic cross-sectional view along line A-A shown in FIG. 1.

Referring to FIG. 3, a partition wall 114 may be provided between the battery cells. The partition wall 114 may be disposed between the battery cells to prevent heat and flame from being transferred between adjacent battery cells. That is, the partition wall 114 may spatially separate the battery cells in the width and length directions or thermally separate the battery cells to prevent heat and flame from being transferred. The partition wall 114 may be manufactured of an insulating material.

When thermal runaway occurs in any one battery cell, the heat and flame generated during the thermal runaway may be prevented from being transferred to other battery cells by the partition wall 114, thereby preventing additional thermal runaway from occurring. In addition, the gas generated from the battery cell during the thermal runaway may be introduced into the gas guide device 200 through the vent hole and the opening portion 203 and discharged to the outside.

FIG. 4 is a schematic cross-sectional view along line B-B shown in FIG. 1.

Referring to FIG. 4, the partition wall 114 and/or a wall cover 115 may be provided between the battery cells. The partition wall 114 and the wall cover 115 may be disposed between the battery cells to prevent heat and flame from being transferred between adjacent battery cells. That is, the partition wall 114 and the wall cover 115 may spatially separate the battery cells in the width and length directions or thermally separate the battery cells to prevent heat and flame from being transferred. The partition wall 114 and/or the wall cover 115 may be manufactured of an insulating material.

When thermal runaway occurs in any one battery cell, the heat and flame generated during the thermal runaway may be prevented from being transferred to other battery cells by the partition wall 114, thereby preventing additional thermal runaway from occurring. In addition, the gas generated from the battery cell during the thermal runaway may be introduced into the gas guide device 200 through the vent hole and the opening portion 203 and discharged to the outside.

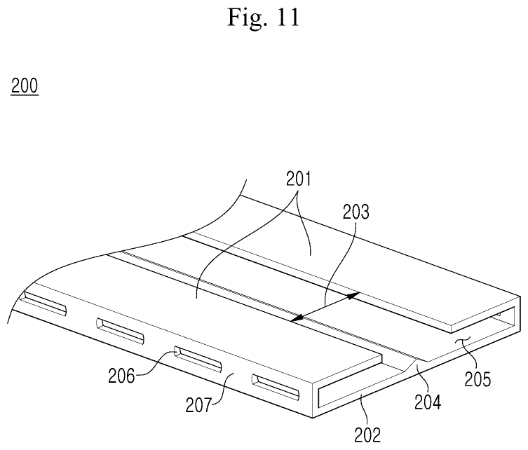

The gas introduced into the gas guide device 200 through the opening portion 203 may be guided to both sides of the gas guide device 200 by the guide portion 204 in the width direction. The gas guide device 200 is provided with a first through-hole 156 that opens in the width direction of the gas guide device 200 (see FIG. 11), and the gas introduced into the gas guide device 200 may move to the first exhaust hole 112 provided at a front end of the first cover 110 or the second exhaust hole 113 provided at the rear end thereof to be discharged to the outside through the first through-hole 156. Since the occurrence of consecutive thermal runaway is prevented by the partition wall 114 and/or the wall cover 115, the gas may be guided to both sides of only one gas guide device 200 in the width directions.

According to one embodiment, the battery housing 20 according to the present disclosure may comprise a first protective member 160 that protects an exhaust path. The first protective member 160 may be provided in the first space 101. The first protective member 160 provides a path along which the gas guided in one side of the gas guide device 200 in the width direction is smoothly discharged to the first exhaust hole 112 and may also protect components around the exhaust hole from a high temperature of the gas.

The shape of the first protective member 160 is not particularly limited. An example in which the first protective member 160 has a rectangular parallelepiped shape is shown in the drawings. The first protective member 160 may be provided with a hole through which a gas is introduced toward the second space 102, and a hole through which a gas is discharged toward the first exhaust hole 112. The gas discharged from the battery cell 31 may be guided by the gas guide device 200 and discharged to the first exhaust hole 112 through the first protective member 160.

In addition, a valve 161 may be provided in the hole of the first protective member 160 facing the first exhaust hole 112. The valve 161 may have a structure that opens when a certain level of a pressure is applied. Therefore, the movement of air or gas through the first exhaust hole 112 is limited by the valve 161 in a normal situation, but the valve 161 may open and exhaust may be performed by a pressure of the gas occurring during thermal runaway.

In addition, the material of the first protective member 160 is not particularly limited, and it may be made of, for example, steel.

FIG. 5 is a schematic cross-sectional view along line C-C shown in FIG. 1.

Referring to FIG. 5, according to one embodiment, the battery housing 20 according to the present disclosure may comprise a second protective member 170 for protecting an exhaust path. The second protective member 170 may be provided in the first space 101. The second protective member 170 provides a path along which the gas guided in the other side of the gas guide device 200 in the width direction is smoothly discharged to the second exhaust hole 113 and may also protect components around the exhaust hole from a high temperature of the gas.

The shape of the second protective member 170 is not particularly limited. An example in which the second protective member 170 has a hollow bar shape is shown in the drawings. The second protective member 170 may be provided with a hole through which a gas is introduced toward the second space 102, and a hole through which a gas is discharged toward the second exhaust hole 113. The gas discharged from the battery cell 31 may be guided by the gas guide device 200 and discharged to the second exhaust hole 113 through the second protective member 170.

In addition, although not shown in the drawings, a valve may be provided in the hole facing the second exhaust hole 113 of the second protective member 170, and the movement of air or gas through the second exhaust hole 113 may be limited by the valve in a normal situation, but the valve 161 may be opened by a pressure of the gas generated during thermal runaway and exhaust may be performed.

In addition, the material of the second protective member 170 is likewise not particularly limited, and it may be made of, for example, steel.

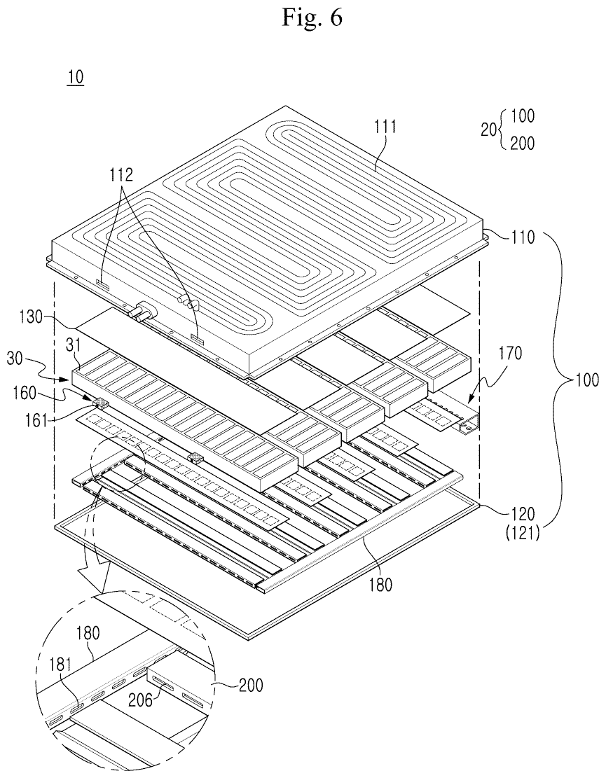

FIG. 6 is a perspective view illustrating a battery pack according to another embodiment of the present disclosure.

Compared to the embodiment shown in FIG. 2, the embodiment shown in FIG. 6 may further comprise a pair of guide members 180 provided on both sides of the gas guide device 200 in a longitudinal direction. Detailed description of the same configurations will be omitted, and differences will be mainly described.

The guide member 180 has a hollow bar shape that is provided long in the width direction of the gas guide device 200, and a plurality of holes 181 disposed in a longitudinal direction of the guide member 180 may be provided on a surface facing the gas guide device 200. That is, a guide member 180 located on one side in the longitudinal direction of the gas guide device 200 and a guide member 180 located on the other side may be disposed to face the holes 181.

As described above, since the partition wall 114 and/or the wall cover 115 is provided between the battery cells to prevent heat and flame from being transferred, additional thermal runaway may be suppressed from occurring in other battery cells due to thermal runaway occurring in one battery cell. However, even when the partition wall 114 and/or the wall cover 115 is provided, there is an exceptional risk that a consecutive thermal runaway may occur or that thermal runaway may occur independently in two or more battery cells.

When thermal runaway occurs in only one battery cell, the gas generated in the battery cell may be guided to both sides of the gas guide device 200 in the width direction by the guide portion 204 as described above.

However, when thermal runaway occurs in two or more battery cells, it may be difficult to secure smooth gas discharge with only the gas guide device 200.

First, when thermal runaway occurs in two or more battery cells in which the vent holes are disposed opposite to the same gas guide device 200 (i.e., two or more battery cells positioned in the same row based on the embodiment illustrated in the drawing), the gas generated in the battery cells may be introduced into the same gas guide device 200 and guided to both sides in the width direction to be discharged to the outside.

Next, when thermal runaway occurs in two or more battery cells in which the vent holes are disposed opposite to another gas guide device 200 (i.e., two or more battery cells positioned in different rows based on the embodiment shown in the drawings), the gas generated in each battery cell is guided to both sides of the corresponding gas guide device 200 in the width direction, but the gases guided in opposite directions may overlap each other in an intermediate area and smooth exhaust may not be performed. However, because the guide member 180 is provided, the exhaust of the overlapping gases may be smoothly performed.

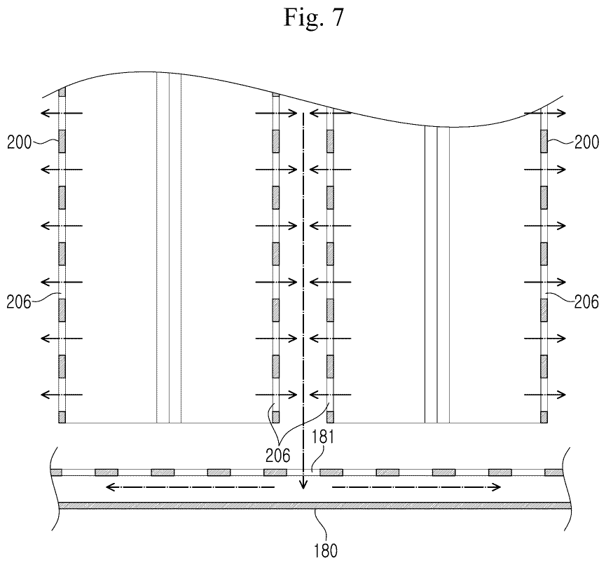

FIG. 7 is a cross-sectional view illustrating a gas guide device and a guide member of FIG. 6.

FIG. 7 shows a state in which a gas is introduced into each of adjacent gas guide devices 200. The gas guided outward in each gas guide device 200 in the width direction may be smoothly discharged to the outside through the first exhaust hole 112 and the second exhaust hole 113, but the gases guided inward in the width direction overlap between the two gas guide devices 200. The overlapping gas moves in the longitudinal direction of the gas guide device 200, and the gas may be introduced into the hollow guide member 180 through the hole 181 and smoothly discharged to the outside through the first exhaust hole 112 and the second exhaust hole 113 in the longitudinal direction of the guide member 180.

FIG. 7 shows a case in which the gas is introduced into each of adjacent gas guide devices 200, but it can be understood in the same way in a case in which the gas is introduced into each of the gas guide devices 200 spaced apart with one or more gas guide devices 200 therebetween.

FIG. 8 is an exploded perspective view illustrating a battery pack according to another embodiment of the present disclosure.

Compared to the embodiment shown in FIG. 2, the second cover 120 may further comprise the upper cover 122 in the embodiment shown in FIG. 8. Detailed description of the same configurations will be omitted, and differences will be mainly described.

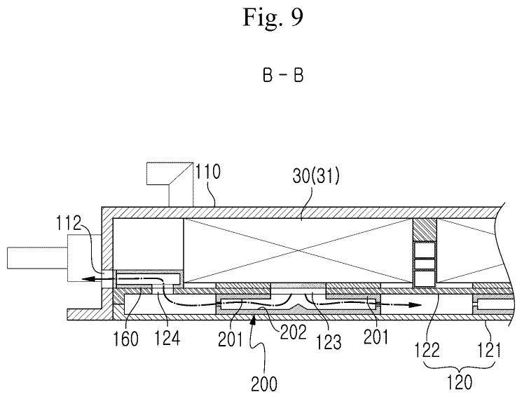

Referring to FIG. 8, according to one embodiment, the second cover 120 further comprises the upper cover 122, and the gas guide device 200 may be accommodated between the upper cover 122 and the lower cover 121. That is, the second space 102 of the second cover 120 may be provided between the upper cover 122 and the lower cover 121. The upper cover 122 may comprise an upper surface of the gas guide device 200, i.e., an upper surface portion on which the first plate 201 is supported, and a side wall portion that protrudes downward from the upper surface portion and is provided with an edge (see FIG. 9).

According to one embodiment, the upper cover 122 may be provided with a communication hole 123 communicating with the opening portion 203 of the gas guide device 200. The first space 101 and the second space 102 may communicate through the communication hole 123. The communication hole 123 may be provided to pass through an inner surface and an outer surface of the upper cover 122. The gas generated in the battery cell 31 during thermal runaway may be introduced into the gas guide device 200 through the communication hole 123. The communication holes 123 may be provided as a plurality of communication holes 123 corresponding to the vent holes of the battery modules 30. An example in which the plurality of communication holes 123 are provided in a plurality of rows to correspond to the arrangement of the battery modules 30 is shown in the drawings. The gas guide device 200 may be provided as a plurality of gas guide devices 200 to correspond to the communication holes 123 to allow all the gases generated in the battery cell 31 to be introduced into the gas guide devices 200. An example in which the plurality of gas guide devices 200 are disposed in parallel to correspond to the arrangement of the battery modules 30 is shown in the drawings.

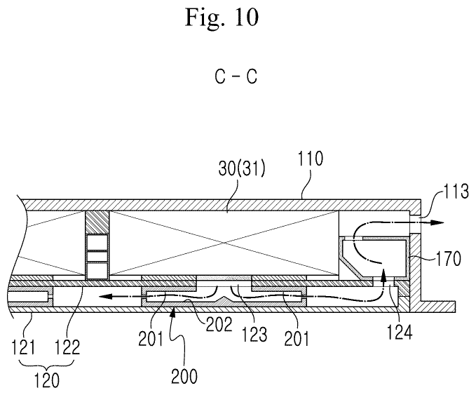

FIG. 9 is a first cross-sectional view illustrating the battery pack shown in FIG. 8. FIG. 10 is a second cross-sectional view illustrating the battery pack shown in FIG. 8. FIG. 9 shows a cross-section corresponding to FIG. 4 in the battery pack shown in FIG. 8. In addition, FIG. 10 shows a cross-section corresponding to FIG. 5 in the battery pack shown in FIG. 8. Similarly, detailed description of the same configurations will be omitted, and differences will be mainly described.

Referring to FIGS. 9 and 10, the upper cover 122 may be provided with a third exhaust hole 124 passing through the inner surface and the outer surface of the upper cover 122. The third exhaust hole 124 may be provided at a front end and a rear end of the upper cover 122 in the drawings and may communicate the first space 101 and the second space 102. Through the third exhaust hole 124, the gas that is introduced into the gas guide device 200 and guided to both sides in the width direction may be discharged to the outside through the first exhaust hole 112 or the second exhaust hole 113.

The third exhaust hole 124 of the upper cover 122 may be positioned to correspond to the holes which face the second space 102 of the first protective member 160 and the second protective member 170 and into which the gas is introduced.

Hereinafter, a structure of the gas guide device 200 will be described in detail.

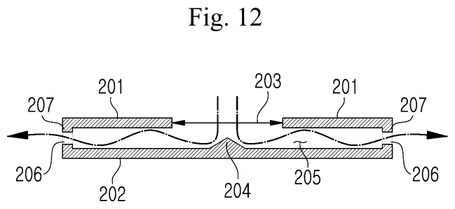

FIG. 11 is a perspective view illustrating the gas guide device according to one embodiment of the present disclosure. FIG. 12 is a cross-sectional view illustrating the gas guide device of FIG. 11.

Referring to FIGS. 11 and 12, according to one embodiment, the second plate 202 may be provided with a guide portion 204. The guide portion 204 may guide a movement path of a gas, foreign materials, etc., which are introduced into the gas guide device 200 through the opening portion 203. That is, the high-temperature and high-pressure gas generated during thermal runaway of the battery cell 31 may be guided by the guide portion 204 and may be smoothly discharged to the outside of the battery housing 20 according to the present disclosure through the first exhaust hole 112 and the second exhaust hole 113. Therefore, stability of the battery pack 10 according to the present disclosure can be improved.

According to one embodiment, the opening portion 203 and the guide portion 204 may be provided at the centers of the first plate 201 and the second plate 202 in the width direction. The gas guide device 200 may have a shape having a constant cross-section in the longitudinal direction, and the opening portion 203 and the guide portion 204 may be provided at the centers of the first plate 201 and the second plate 202, respectively, in the width direction. The gas introduced through the opening portion 203 may be guided to both sides in the width direction by the guide portion 204 and discharged to the outside.

According to one embodiment, the guide portion 204 protrudes to be tapered so that both side surfaces may be provided to be inclined. Although an example in which the guide portion 204 has a triangular cross-section is shown in the drawings, the shape of the guide portion 204 is not limited thereto. Since the guide portion 204 has the tapered protruding shape, the gas introduced into the space 205 through the opening portion 203 positioned to face the guide portion 204 may be guided to both sides in the width direction and discharged to the outside.

According to one embodiment, the gas guide device 200 may further comprise a support 207 having an inner surface facing the space 205 and connecting the first plate 201 and the second plate 202. The support 207 may form an outer wall of the gas guide device 200. That is, the space 205 may be provided between the first plate 210, the second plate 202, and the support 207.

According to one embodiment, the support 207 may be provided with a first through-hole 206 passing through an inner surface and an outer surface of the support 207. That is, the gas introduced into the space 205 through the opening portion 203 and guided to both sides in the width direction by the guide portion 204 may move to the outside of the gas guide device 200 through the first through-hole 206 of the support 207 and may be discharged from the battery housing 20 according to the present disclosure through the first exhaust hole 112 and the second exhaust hole 113.

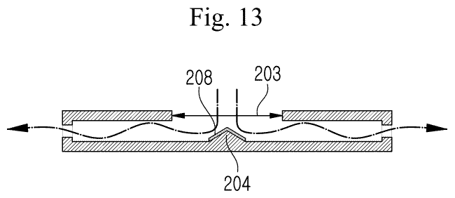

FIG. 13 is a cross-sectional view illustrating a gas guide device according to another embodiment of the present disclosure.

Referring to FIG. 13, according to one embodiment, the gas guide device 200 may further comprise a cover member 208 covering a surface of the guide portion 204. The cover member 208 may be provided to prevent the shape of the guide portion 204 from being deformed by the high-temperature and high-pressure gas generated in the battery cell 31 and introduced through the opening portion 203. The cover member 208 may be manufactured of heat-resistant materials such as MICA and steel use stainless (SUS). Since the guide portion 204 is covered by the cover member 208, the shape of the guide portion 204 may be maintained even when the high-temperature gas is introduced, and thus the high-temperature gas may be guided to be smoothly discharged to the outside.

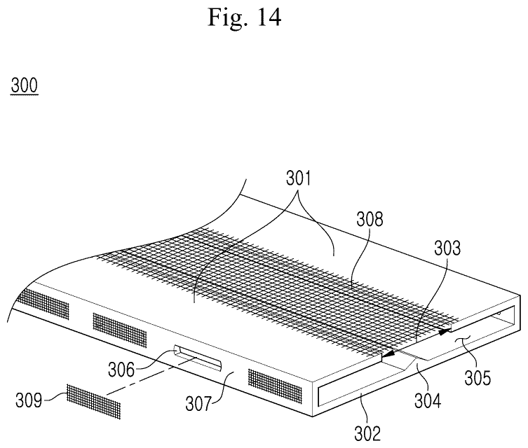

FIG. 14 is a perspective view illustrating a gas guide device according to yet another embodiment of the present disclosure. For the same matters identical to those of the embodiment shown in FIG. 11, a detailed description will be omitted, and the differences will be mainly described.

Referring to FIG. 14, according to one embodiment, a gas guide device 300 that further comprises a first net 308 covering an opening portion 303 may be provided. Due to the first net 308, a flame generated during thermal runaway of a battery cell 31 may be prevented from being directly introduced into the gas guide device 200. Accordingly, gas discharge by the gas guide device 200 may be guided to both sides in the width direction and smoothly performed by a guide portion 304, and stability of a battery pack 10 can be improved.

According to one embodiment, the gas guide device 300 may further comprise a second net 309 covering a first through-hole 306. Due to the second net 309, conductive particles contained in the gas introduced into a space 305 may be prevented from being discharged to the outside of the gas guide device 300. In addition, foreign materials generated when the case of battery cell 31 and surrounding components are melted due to the high temperature generated during thermal runaway may be introduced into the space 305 together with the gas but may be blocked from being discharged to the outside of the gas guide device 300. That is, due to the second net 309, the foreign materials contained in the gas introduced into the space 305 may be prevented from being discharged to the outside of a battery housing 20 according to the present disclosure.

According to one embodiment, holes of the second net 309 may be smaller than holes of the first net 308. According to one embodiment, the gas guide device 300 according to the present disclosure further comprises the first net 308 covering the opening portion 303, a support 307 having the first through-hole 306 facing the space 305 on an inner surface, connecting a first plate 301 and a second plate 302, and passing through an inner surface and an outer surface of the support 307, and the second net 309 covering the first through-hole 306, and the holes of the second net 309 may be smaller than the holes of the first net 308. Since the holes of the second net 309 are smaller than the holes of the first net 308, that is, the second net 309 has a closer spacing than the first net 308, the foreign materials contained in the gas may pass through the first net 308 to be introduced into the space 305, but may not pass through the second net 309 and may be isolated inside the gas guide device 300.

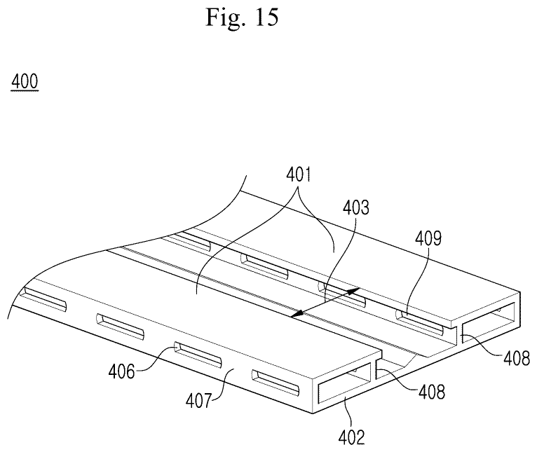

FIG. 15 is a perspective view illustrating a gas guide device according to yet another embodiment of the present disclosure. For the same matters identical to those of the embodiment shown in FIG. 11, a detailed description will be omitted, and the differences will be mainly described.

Referring to FIG. 15, according to one embodiment, a gas guide device 400 that further comprises a reinforcement 408 connecting a first plate 401 and a second plate 402 therein may be provided. A support 407 may connect the first plate 401 and the second plate 402 on an outer side in the width direction, and the reinforcement 408 may connect the first plate 401 and the second plate 402 on an inner side in the width direction. A load of a battery module 30 applied to the gas guide device 400 is supported by the reinforcement 408, and rigidity can be improved. That is, according to the design of the battery housing according to the present disclosure, the battery module 30 may be positioned above the gas guide device 400, and the load of the battery module 30 may be applied to the gas guide device 400. Since the reinforcement 408 is further provided, the rigidity can be improved and the shape of the gas guide device 400 can be maintained. Therefore, stability of the battery pack 10 can be improved. When the gas guide device 400 is provided as a plurality of gas guide devices 400, the reinforcement 408 may be selectively installed only in some gas guide devices 400 on which the load is concentrated.

According to one embodiment, the reinforcement 408 may be provided with a second through-hole 409 passing through an inner surface and an outer surface of the reinforcement 408. The opening portion 403 and the first through-hole 406 are spatially connected by the second through-hole 409, and the gas introduced into the opening portion 403 may be discharged to the outside of the gas guide device 400 through the second through-hole 409 and the first through-hole 406.

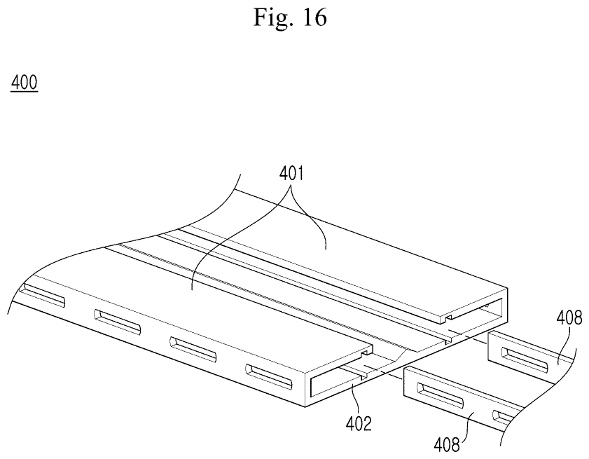

FIG. 16 is a perspective view illustrating a gas guide device according to yet another embodiment of the present disclosure. For the same matters identical to those of the embodiment shown in FIG. 11, a detailed description will be omitted, and the differences will be mainly described.

Referring to FIG. 16, a reinforcement 408 may be provided to be detachable from a first plate 401 and a second plate 402. That is, the reinforcement 408 may be selectively coupled to or decoupled from the first plate 401 and the second plate 402. Inner surfaces of the first plate 401 and the second plate 402 are provided with grooves into which the reinforcement 408 may be inserted, and the reinforcement 408 may slide in a longitudinal direction of the reinforcement 408 to be inserted into the grooves of the first plate 401 and the second plate 402. The reinforcement 408 may be coupled to all of the plurality of gas guide devices 400, or the reinforcement 408 may be coupled to only some gas guide devices 400 and may not be coupled to the remaining gas guide devices 400. The reinforcement 408 may be selectively coupled to only some gas guide devices 400 on which the load is concentrated.

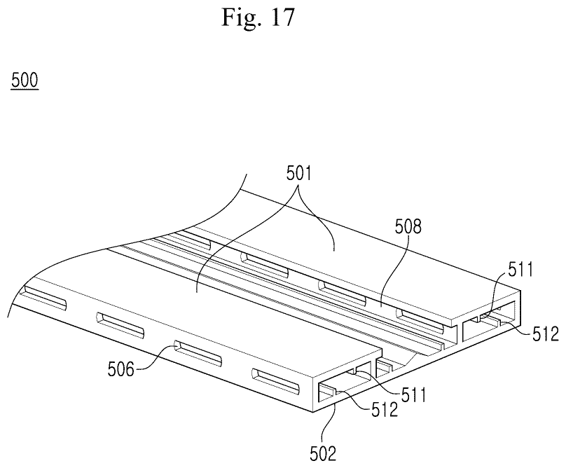

FIG. 17 is a perspective view illustrating a gas guide device according to yet another embodiment of the present disclosure. For the same matters identical to those of the embodiment shown in FIG. 11, a detailed description will be omitted, and the differences will be mainly described.

Referring to FIG. 17, according to one embodiment, a gas guide device 500 in which a first plate 504 is provided with a first rib 511 protruding toward the second plate 502 may be provided.

According to one embodiment, the gas guide device 500 in which the second plate 502 is provided with a second rib 512 protruding toward the first plate 501 may be provided.

Based on the drawing, the first rib 511 may protrude from a lower surface of the first plate 501. The second rib 512 may protrude from an upper surface of the second plate 502. In addition, when both the first rib 511 and the second rib 512 are provided, the first rib 511 and the second rib 512 may be disposed alternately. An inflow of outdoor air through the first through-hole 506 from the outside of the gas guide device 500 may be suppressed by the first rib 511 and the second rib 512. By suppressing the inflow of outdoor air, the supply of oxygen to the battery cells is minimized, which can delay or suppress thermal runaway.

According to the gas guide device and the battery pack having the above-described structure, a discharge path for a high-temperature and high-pressure gas generated in a battery cell can be guided. In addition, a flame backflow can be prevented. In addition, foreign materials such as conductive particles can be prevented from being discharged to the outside. In addition, stability of the battery pack can be improved. In addition, rigidity of the battery pack can be improved.

According to some embodiments of the present disclosure, a battery housing and a battery pack can be provided.

According to some embodiments of the present disclosure, a high-temperature and high-pressure gas generated in a battery cell can be guided along a discharge path.

According to some embodiments of the present disclosure, a flame backflow can be prevented.

According to some embodiments of the present disclosure, foreign materials such as conductive particles can be prevented from being discharged to the outside.

According to some embodiments of the present disclosure, stability of the battery pack can be improved.

According to some embodiments of the present disclosure, rigidity of the battery pack can be improved.

However, the technical effects obtainable through the embodiments of the present disclosure are not necessarily limited to the above-mentioned effects. Other technical effects that have not been mentioned will be clearly understood by those skilled in the art to which the present disclosure pertains from other descriptions of the specification, such as the detailed description.

The content described above is merely an example of applying the principle of the present disclosure, and other configurations may be further comprised without departing from the scope of the present disclosure.

What is claimed is:

1. A battery housing comprising:
a gas guide device having first and second plates spaced apart from each other with a space therebetween; and
a case in which a battery module and the gas guide device are accommodated,
wherein an opening portion is provided to pass through the first plate and is connected to the space,
a guide portion protruding toward the opening portion is provided on the second plate, and
the gas guide device being arranged so that the opening portion is oriented toward the battery module.

2. The battery housing of claim 1, wherein the case comprises a first cover in which the battery module is accommodated and one side of which is open, and a second cover in which the gas guide device is accommodated and which is coupled to the open side of the first cover.

3. The battery housing of claim 2, wherein the second cover comprises a lower cover on which the second plate is supported.

4. The battery housing of claim 1, wherein the gas guide device is coupled to the case using an adhesive.

5. The battery housing of claim 1, wherein the gas guide device is coupled to the case by bolting.

6. The battery housing of claim 3, wherein:
the second cover further comprises an upper cover; and
the gas guide device is accommodated between the upper cover and the lower cover.

7. The battery housing of claim 6, wherein the upper cover is provided with a communication hole communicating with the opening portion.

8. The battery housing of claim 1, wherein the opening portion and the guide portion are provided at centers of the first plate and the second plate in a width direction.

9. The battery housing of claim 1, wherein the guide portion protrudes to be tapered so that both surfaces in a width direction are provided to be inclined.

10. The battery housing of claim 1, wherein the gas guide device further comprises a cover member covering a surface of the guide portion.

11. The battery housing of claim 1, wherein the gas guide device further comprises a first net covering the opening portion.

12. The battery housing of claim 1, wherein the gas guide device further comprises a support whose inner surface faces the space and which connects the first plate and the second plate.

13. The battery housing of claim 12, wherein a first through-hole is provided to pass through an inner surface and an outer surface of the support.

14. The battery housing of claim 13, wherein the gas guide device further comprises a second net covering the first through-hole.

15. The battery housing of claim 1, wherein the gas guide device further comprises:
a first net covering the opening portion;
a support whose inner surface faces the space and which connects the first plate and the second plate and is provided with a first through-hole passing through an inner surface and an outer surface thereof; and
a second net covering the first through-hole,
wherein a hole of the second net is smaller than a hole of the first net.

16. The battery housing of claim 15, wherein the gas guide device comprises a reinforcement connecting the first plate and the second plate on an inner side rather than the support.

17. The battery housing of claim 16, wherein a second through-hole is provided to pass through an inner surface and an outer surface of the reinforcement.

18. The battery housing of claim 1, wherein a first rib protruding toward the second plate is provided on the first plate.

19. The battery housing of claim 1, wherein a second rib protruding toward the first plate is provided on the second plate.

20. A battery pack comprising:
the battery housing according to claim 1; and
a battery module accommodated in the case.
